(19) United States
(12) Patent Application Publication
(10) Pub. No.: US 2013/0100501 A1
(43) Pub. Date: Apr. 25, 2013

(54) CLOUD PROCESSING METHOD WITH IDENTIFICTION MECHANISM AND SYSTEM USING THE SAME

(71) Applicants: Chi-Yuan Chen, Taipei City (TW); Chih-Shin Lan, Taipei City (TW)

(72) Inventors: Chi-Yuan Chen, Taipei City (TW); Chih-Shin Lan, Taipei City (TW)

(73) Assignee: TEKNOWLEDGE DEVELOPMENT CORP., Taipei City (TW)

(21) Appl. No.: 13/551,619

(22) Filed: Jul. 18, 2012

(30) Foreign Application Priority Data
Oct. 21, 2011 (TW) 100138265

(51) Int. Cl. G06K 15/02; H04N 1/04

(52) U.S. Cl. 358/3.28; 358/474; 358/1.14; 358/1.13

(57) ABSTRACT

A cloud processing method with identification mechanism is provided. The method is adapted for processing a document, and includes following procedures. One or more corresponding processing procedures are configured for the document; identification information of the corresponding processing procedures are obtained; a cover page including the identification information is obtained; the cover page and the document are scanned for obtaining the identification information and generating a scanned document; and the document is processed by one or more corresponding processing procedures according to the identification information of the cover page.

### CROSS-REFERENCE TO RELATED APPLICATION

This application claims the priority benefit of Taiwan application serial no. 100138265, filed on Oct. 21, 2011. The entirety of the above-mentioned patent application is hereby incorporated by reference herein and made a part of this specification.

### BACKGROUND OF THE INVENTION

1. Field of the Invention

The invention relates to a document automatic processing mechanism. Particularly, the invention relates to a cloud processing method with an identification mechanism and a system using the same method.

2. Description of Related Art

Paper documents produced in office routine are generally filed and stored in a file cabinet after utilization. However, such file storage method is not efficient, and if a corresponding index look-up table is not created in advance, after the paper documents are stored in the file cabinet, it is not easy to find a specific document from the large amount of stored documents from the file cabinet, and it is also difficult for users to search the stored documents. Therefore, if the paper documents are automatically stored in an electronic database, and a computer is configured to create an index look-up table of the electronic documents to facilitate data searching, the aforementioned problem is resolved. However, some documents, for example, signature documents, have to be scanned for storing in the electronic database, and an operation method of a scanning or photo-capturing device in current market does not assist simultaneously storing a plurality of scanned documents in the database and creating an index look-up table for these documents. Therefore, how to use a document scanning function and a subsequent automatic document processing flow to store or transmit an electronic version of the paper document to a proper destination and easily access the same document after the automatic document processing is an important issue to be developed.

### SUMMARY OF THE INVENTION

Accordingly, the invention is directed to a cloud processing method with an identification mechanism and a system using the same method, by which a scanning device, a printing device and a cloud processing device are configured to greatly improve operation efficiency of document transmission, document filing, or other document processing procedures.

An exemplary embodiment of the invention provides a cloud processing method with an identification mechanism. According to an embodiment of the invention, the method is adapted to process a document, and includes following steps. One or a plurality of corresponding processing procedures is configured for the document. Identification information of the corresponding processing procedures are obtained. A cover page including the identification information is obtained. The cover page and the document are scanned for obtaining the identification information and generating a scanned document. The document is processed by one or more corresponding processing procedures according to the identification information of the cover page.

An exemplary embodiment of the invention provides a cloud processing system. The cloud processing system is adapted to process a document and includes a cloud processing device, a document printing device and a scanning or photo-capturing device. The cloud processing device is configured for receiving one or a plurality of corresponding processing procedures of the document configured by a user, and generating identification information of the one or a plurality of corresponding processing procedures. The document printing device is connected to the cloud processing device, and is configured to generate a cover page including the identification information. Moreover, the scanning or photo-capturing device is connected to the cloud processing device, and scans the cover page and the document for obtaining the identification information and generating a scanned document, and provides the scanned document and the identification information to the cloud processing device. The cloud processing device processes the document by one or more corresponding processing procedures according to the identification information of the cover page.

According to the aforementioned descriptions, the invention provides the cloud processing method with the identification mechanism and the system using the same method. By configuring one or more corresponding processing procedures for the document, the identification information of the corresponding processing procedures and the cover page having the identification information are obtained from the cloud processing device, and when the scanning or photo-capturing device is configured to scan the document and the corresponding cover page, the cloud processing device processes the documents by one or more corresponding processing procedures according to the identification information of the cover page. In this way, a single document can be processed by a plurality of corresponding processing approaches by performing one configuring procedure and one scanning procedure.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a system structure diagram of a cloud processing system according to an exemplary embodiment of the invention.

FIG. 2 is a schematic diagram of identification (ID) information according to an exemplary embodiment of the invention.

FIG. 3 is a schematic diagram of identification information according to another exemplary embodiment of the invention.

FIG. 4 is a flowchart illustrating a cloud processing method with an identification mechanism according to an exemplary embodiment of the invention.

FIG. 5 is a flowchart illustrating a cloud processing method with an identification mechanism according to an exemplary embodiment of the invention.

FIG. 6 is a system structure diagram of another cloud processing system according to an exemplary embodiment of the invention.

FIG. 7 is a schematic diagram of identification information according to another exemplary embodiment of the invention.

FIG. 8 is a flowchart illustrating a cloud processing method with an identification mechanism according to an exemplary embodiment of the invention.

FIG. 9 is a flowchart illustrating a cloud processing method with an identification mechanism according to an exemplary embodiment of the invention.

FIG. 10 is a flowchart illustrating a cloud processing method with an identification mechanism according to an exemplary embodiment of the invention.

FIG. 11 is a flowchart illustrating a cloud processing method with an identification mechanism according to an exemplary embodiment of the invention.

FIG. 12 is a flowchart illustrating a cloud processing method with an identification mechanism according to an exemplary embodiment of the invention.

### DETAILED DESCRIPTION OF DISCLOSED EMBODIMENTS

The invention provides a cloud processing method with identification (ID) mechanism and a system using the same method. To facilitate describing the cloud processing method and the system using the same method, the cloud processing system is introduced first, and a possible implementation flowchart of the cloud processing method is introduced with reference of the cloud processing system. It is noted that the cloud processing method and the cloud processing system introduced below are merely used to describe possible implementations, which are not intended to limit the claims of the invention and possible modifications thereof.

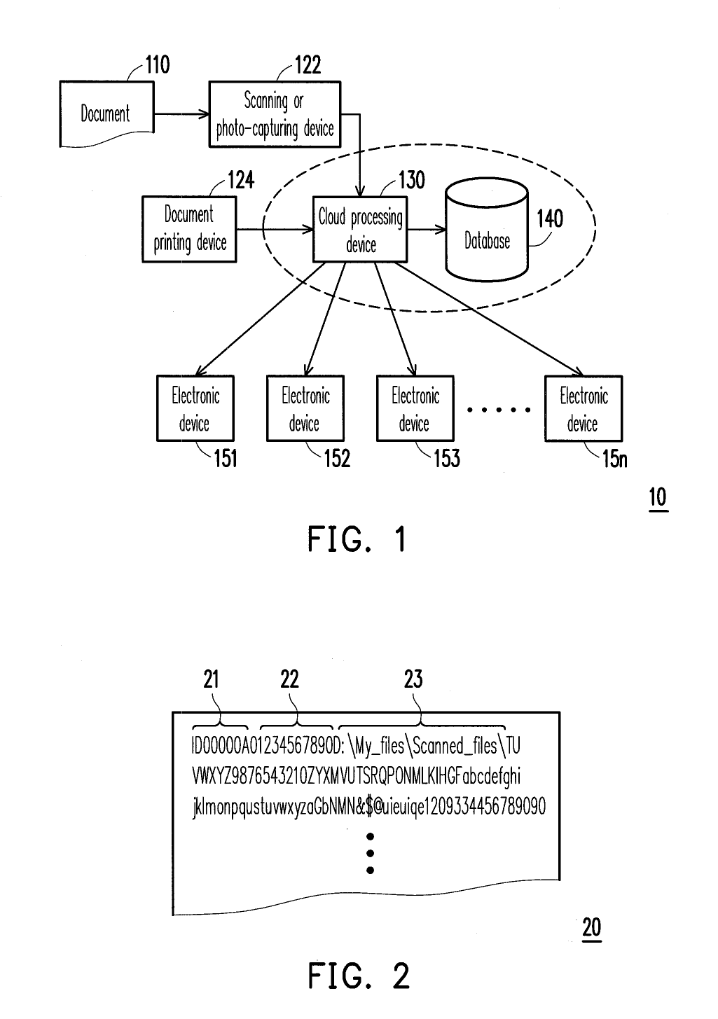

FIG. 1 is a system structure diagram of a cloud processing system according to an exemplary embodiment of the invention. Referring to FIG. 1, the cloud processing system 10 includes a scanning or photo-capturing device 122, a document printing device 124, a cloud processing device 130, a database 140 and a plurality of electronic devices 151, 152, 153, . . . , 15n, where n is a positive integer. In the present embodiment, the cloud processing device 130 and the database 140 are located at a far end, which are core portions of a computing cloud, while the scanning or photo-capturing device 122 and the document printing device 124 are located at a local end close to users. The electronic devices 151, 152, 153, . . . , 15n can be located at the local end or the far end, which are not introduced one-by-one.

Referring to FIG. 1, in the present embodiment, the scanning or photo-capturing device 122 is configured to scan a document 110, and is connected the cloud processing device 130 through the Internet, a virtual private network or a local area network (LAN). The scanning or photo-capturing device 122 transmits the scanned document (an electronic document) to the cloud processing device 130 for processing by one or more processing procedures, and processing of the scanned document is described in detail below. The cloud processing device 130 is connected to the database 140 and the document printing device 124 through the Internet, the virtual private network or the LAN, and processes the received scanned document and provides identification (ID) information corresponding to a cover page of the scanned document to one of the electronic devices 151, 152, 153, . . . , 15n or the document printing device 124, or transmits or stores the scanned document to one of the electronic devices 151, 152, 153, . . . , 15n.

The user can firstly log in the cloud processing device 130 through one of the electronic devices 151, 152, 153, . . . , 15n located at the local end to obtain user ID information from the cloud processing device 130. After obtaining the user ID information, the user can configure one or a plurality of processing procedures of the one or a plurality of documents to be processed on the cloud processing device 130, and obtains the cover pages or the ID information corresponding to the single or a plurality of documents from the cloud processing device 130.

For the sake of simplicity, the electronic device 151 is taken as an example for description. The electronic device can be a fax machine, a database storage device, a computer, a flat panel computer, a smart phone or a handheld computing device. The user can firstly log in the cloud processing device 130 through the electronic device 151, and obtains the user ID information from the cloud processing device 130. After the user ID information is obtained, for example, it is assumed in the present embodiment that the user is about to store or transmit three documents (a first document, a second document and a third document) to different destinations (a first electronic device, a second electronic device and a third electronic device), so the user can respectively configure corresponding processing procedures of the three documents on the cloud processing device 130. Then, the cloud processing device 130 generates corresponding processing ID information according to the corresponding processing procedures of the three documents and the user ID information, and finally generate and provide the ID information to the electronic device 151.

The electronic device 151 is connected to the printing device 124 through the Internet, the virtual private network or the LAN. After the user obtains the ID information through the electronic device 151, the ID information is printed on a cover page through the document printing device 124, or the ID information is printed as a one-dimensional barcode, or the ID information is printed as a two-dimensional barcode (for example, a QR code). It is noted that the ID information includes the user ID information and the processing ID information. Moreover, in a practical operation, the user can manually write the ID information on the cover page, or manually attach the one-dimensional barcode on the cover page, or manually attach the two-dimensional barcode on the cover page. In other embodiment, the cloud processing system may further include an electronic tag (for example, a radio frequency identification (RFID) tag) burner (not shown in FIG. 1), which can burn the ID information on an electronic tag, and the electronic tag can be attached to the cover page, and the scanning or photo-capturing device 122 simultaneously has a functionality of reading the electronic tag.

After the user obtains the complete cover pages, the user uses the scanning or photo-capturing device 122 to scan the documents and the cover pages to obtain electronic documents (scanned documents), and obtain the ID information of the cover pages. It is noted that the cover page has to be scanned first, and then the other pages of the document are scanned. For example, when the user selects three documents to respectively configure three cover pages for the selected three documents, the scanning or photo-capturing device 122 uses optical character recognition (OCR) functionality to respectively recognize the ID information of each one of the cover pages (the ID information can be, for example, a one-dimensional barcode, a two-dimensional barcode, or combination information of a string of characters or symbols), or read the ID information from electronic tags. After obtaining the recognized ID information, the scanning or photo-capturing device 122 transmits the scanned documents and the recognized ID information to the cloud processing device 130 for subsequent processing. The cloud processing device 130 stores the scanned documents to the database 140, to a pre-configured path of the electronic device 151 or to one of the electronic devices 151, 152, 153, . . . , 15n according to the processing ID information in the ID information of the scanned documents.

In the present embodiment, the cloud processing device 130 can be a server, which can process a plurality of scanned documents and map the corresponding processing procedures configured by the user and the user ID information in a mapping table. For example, Table 1 shown below is an exemplary mapping table, which lists processing ID information corresponding to processing procedures of different documents configured by three users, and a sequence thereof is arranged according to a timing sequence that the users configure the processing procedures.

For example, a first user with user ID information “ID00000A” firstly configures a processing procedure of a first document to obtain processing ID information “1234567890”. It may be deduced by analogy, a second user with user ID information “ID00000B” obtains processing ID information “0000EFGH” of a second document, the first user with the user ID information “ID00000A” obtains processing ID information “0000ABCD” of a third document, a third user with user ID information “ID00000C” obtains processing ID information “0000MNOP” of a fourth document, the second user with the user ID information “ID00000B” obtains processing ID information “0000QRST” of a fifth document, and the first user with the user ID information “ID00000A” obtains processing ID information “XYZ98765” of a sixth document.

TABLE 1

| User ID | Processing ID | |
|---|---|---|
| information | information | Processing approach |
| ID00000A | 1234567890 | Store a first document to a |
| | | first pre-configured path of a |
| | | first electronic device |
| ID00000B | 0000EFGH | Transmit a second document |
| | | to a fax number of a third |
| | | electronic device |
| ID00000A | 0000ABCD | Transmit a third document to |
| | | a plurality of email addresses |
| ID00000C | 0000MMOP | Store a fourth document to a |
| | | database |
| ID00000B | 0000QRST | Mail a fifth document to a |
| | | plurality of physical mailing |
| | | addresses |
| ID00000A | XYZ98765 | Store a sixth document to a |
| | | second pre-configured path |
| | | of the first electronic device |

Meanwhile, each processing ID information shown in FIG. 1 has a corresponding processing approach, and when the cloud processing device 130 receives the ID information of each one of the cover pages and the corresponding scanned document from the scanning or photo-capturing device 122, the cloud processing device 130 processes each one of the scanned documents according to the corresponding processing ID information of the scanned document.

For example, when the cloud processing device 130 obtains the first document from the scanning or photo-capturing device 122, the cloud processing device 130 stores the first document to a first pre-configured path of the first electronic device (for example, the electronic device 151) according to the processing ID information of the first document. When the cloud processing device 130 obtains the second document, the cloud processing device 130 transmits the second document to a fax number of the third electronic device (for example, the electronic device 153) according to the processing ID information of the second document. When the cloud processing device 130 obtains the third document, the cloud processing device 130 transmits the third document to a plurality of email addresses (for example, email addresses corresponding to the electronic devices 151 and 152) according to the processing ID information of the third document. When the cloud processing device 130 obtains the fourth document, the cloud processing device 130 stores the fourth document to a database (for example, the database 140) according to the processing ID information of the fourth document. When the cloud processing device 130 obtains the fifth document, the cloud processing device 130 mails the fifth document to a plurality of physical mailing addresses (which can be carried on by an express corporation or a mail delivery company) according to the processing ID information of the fifth document. When the cloud processing device 130 obtains the sixth document, the cloud processing device 130 stores the sixth document to a second pre-configured path of the first electronic device according to the processing ID information of the sixth document.

However, the invention is not limited to the Table 1, and in other embodiments, the cloud processing device 130 can process documents for more than three users can be dealt with or executing corresponding processing procedures for more than six documents. Furthermore, the invention is not limited to one scanning or photo-capturing device, and in a cloud processing system of another embodiment, a plurality of scanning or photo-capturing device can be configured to process a plurality of user documents of different geographical locations. In addition, in other embodiments, the scanning or photo-capturing device 122 can be integrated with the document printing device 124 to form, for example, a commonly-used multi-function printer, though the invention is not limited thereto.

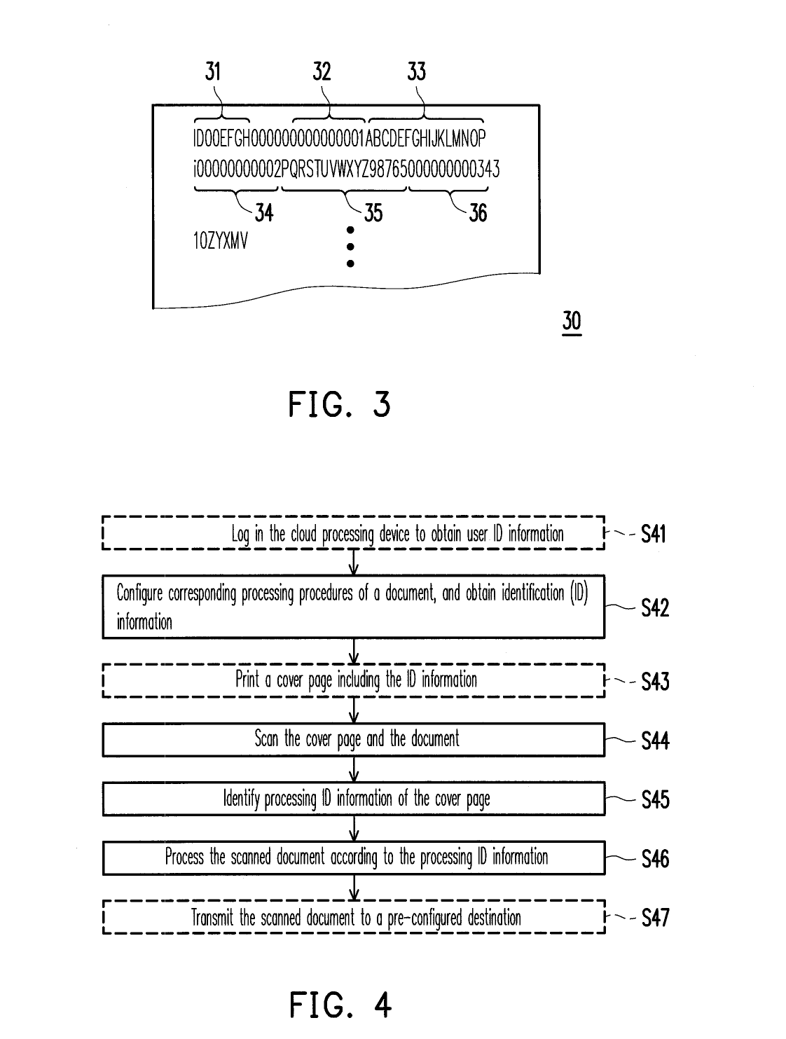

Embodiments are provided below to introduce the ID information of the cover page with reference of FIG. 2 and FIG. 3. FIG. 2 is a schematic diagram of ID information according to an exemplary embodiment of the invention. Referring to FIG. 2, the ID information 20 is a combination of a string of characters, numbers and symbols, which may include the user ID information “ID00000A” indicated by a reference number 21, the processing ID information “1234567800” indicated by a reference number 22, and the other information “ABCDEFGHIJKLMNOPQRS” indicated by a reference number 23 which indicates relative path information of the first pre-configured path required by the processing ID information “1234567800”. Combinations of other characters, numbers or symbols in the ID information may represent other types of processing ID information and related information, for example, the scanned document corresponding to the ID information is transmitted to one or a plurality of fax numbers (not shown), or is transmitted to one or a plurality of email addresses (not shown), or is mailed to one or a plurality of physical mailing addresses, and actual meanings of the characters, the numbers and the symbol are not described in detail one-by-one. It is noted that the physical mailing address includes a post office box number.

FIG. 3 is a schematic diagram of ID information according to another exemplary embodiment of the invention. Referring to FIG. 3, the ID information 30 is a combination of a string of characters, numbers and symbols, which may include the user ID information “0000EFGH” indicated by a reference number 31, a part of the processing ID information “0000000001” indicated by a reference number 32 which indicates to perform a subsequent processing on a page “0000000001”, and a part of the processing ID information “ABCDEFGHIJKLMNOP” indicated by a reference number 33 which indicates a processing procedure of the page “0000000001”. Meanwhile, a part of the processing ID information “0000000002” indicated by a reference number 34 indicates to perform a subsequent processing on a page “0000000002”, a part of the processing ID information “PQRSTUVWXYZ98765” indicated by a reference number 34 indicates a processing procedure of the page “0000000002”, and a part of the processing ID information “0000000003” indicated by a reference number 36 indicates to perform a subsequent processing on a page “0000000003”, though introduction of the processing procedure thereof is not continued. Combinations of other characters, numbers or symbols in the ID information may represent other types of processing ID information and related information, for example, the scanned document corresponding to the ID information is transmitted to one or a plurality of fax numbers (not shown), or transmitted to one or a plurality of email addresses (not shown), or mailed to one or a plurality of physical mailing addresses, and actual meanings of the characters, the numbers and the symbol are not described in detail one-by-one.

According to another aspect, the cloud processing system 10 is adapted to process one or a plurality of documents, and at least includes the cloud processing device 130, the document printing device 124 and the scanning or photo-capturing device 122. The cloud processing device 130 is configured for receiving one or a plurality of corresponding processing procedures of a document configured by a user, and generating ID information of the one or a plurality of corresponding processing procedures. The document printing device 124 is connected to the cloud processing device 130, and is configured to generate a cover page including the ID information. Moreover, the scanning or photo-capturing device 122 is connected to the cloud processing device 130, and scans the cover page and the document for obtaining the ID information and generating a scanned document, and provides the scanned document and the ID information to the cloud processing device 130. Then, the cloud processing device 130 processes the document by one or more corresponding processing procedures according to the ID information of the cover page.

By using the scanning or photo-capturing device, the document printing device, the network and the cloud processing device, the cloud processing system 10 can greatly improve efficiencies for document transmission, document filing, or other document processing procedures. Moreover, since the cover page records the ID information required by the cloud processing device for processing the document, it is unnecessary for the user to configure a document storage location or a document transmitting destination manually on the scanning or photo-capturing device, so operation complexity of the user is greatly reduced. Meanwhile, it also reduces time required to wait for operating the scanning or photo-capturing device when multiple users use the scanning or photo-capturing device.

FIG. 4 is a flowchart illustrating a cloud processing method with an ID mechanism according to an exemplary embodiment of the invention. Referring to FIG. 4, the cloud processing method is adapted to the cloud processing system 10 shown in FIG. 1, which includes following steps. A user uses an electronic device to log in the cloud processing device to obtain user ID information (step S41). The user configures corresponding processing procedures of a document to be processed on the cloud processing device through the electronic device, and obtains ID information from the cloud processing device (step S42), where the ID information includes the user ID information and processing ID information. The user configures a document printing device to print a cover page including the ID information (step S43). The user uses a scanner or photo-capturing device to scan the cover page and the document to be processed (step S44). The scanner or photo-capturing device identifies the processing ID information of the cover page, and generates a scanned document, and transmits the processing ID information and the scanned document to the cloud processing device (step S45). The cloud processing device processes the scanned document according to the processing ID information (step 46). Then, the cloud processing device transmits the scanned document to a pre-configured destination (step S47).

In the step S47, the destination is, for example, one or a plurality of email addresses, one or a plurality of fax numbers, one or a plurality of physical mailing addresses, a database, or pre-configured paths of one or a plurality of electronic devices, etc. When the user has obtained the user ID information, and a cloud processing of the document is performed for a next time, the step S41 can be skipped to directly execute the step S42.

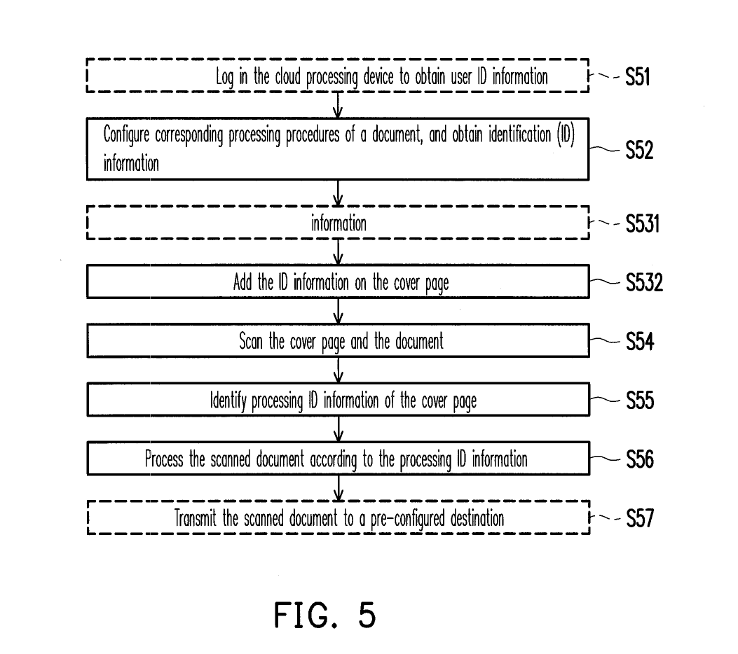

FIG. 5 is a flowchart illustrating a cloud processing method with an ID mechanism according to an exemplary embodiment of the invention. Referring to FIG. 5, the cloud processing method is similar to the cloud processing method of FIG. 4, though the cloud processing method of the embodiment further includes following steps: the user uses the document printing device to print a cover page (step S531), and the user adds the ID information on the cover page (step S532), which are configured to replace the step S42. Regarding practical implementations of the step S532, the user can attach a one-dimensional barcode or a two-dimensional barcode to the cover page, or manually write a combination of a string of characters or symbols onto the cover page, or manually attach an electronic tag on the cover page.

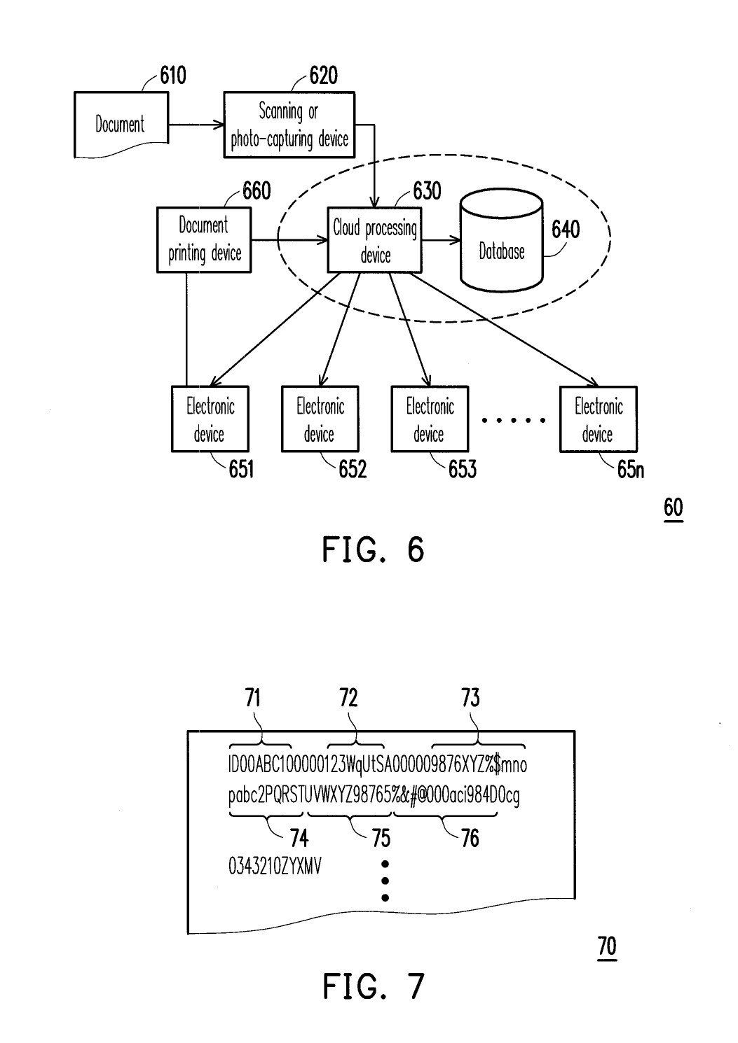

FIG. 6 is a system structure diagram of another cloud processing system according to an exemplary embodiment of the invention. The structure of the cloud processing system 60 is similar to that of the cloud processing system 10 of FIG. 1, though the cloud processing system 10 is a private cloud, the cloud processing system 60 is a public cloud. For the sake of simplicity, merely a part of components are illustrated in FIG. 6.

Referring to FIG. 6, the cloud processing system 60 includes a scanning or photo-capturing device 620, a document printing device 624, a cloud processing device 630, a database 640 and a plurality of electronic devices 651, 652, 653, . . . , 65n, where n is a positive integer. In the present embodiment, the cloud processing device 630 and the database 640 are located at the far end, which are core portions of a computing cloud 6, while the scanning or photo-capturing device 620 and the document printing device 624 are located at a local end close to the user. The electronic devices 651, 652, 653, . . . , 65n can be located at the local end or the far end, which are not introduced one-by-one. The cloud processing system 60 can support more than one scanning or photo-capturing device and more than one document printing device.

In the present embodiment, the scanning or photo-capturing device 620 can be located at a convenience store, a library, an art gallery or a museum, and so forth. The document printing device 624 can be located at neighboring area of an electronic device currently operated by the user, for example, the user's office, the user's home, or a library, an art gallery or a museum currently visited by the user (and these public areas are equipped with the electronic devices to allow the user logging in the cloud processing device 630).

Referring to FIG. 6, in the present embodiment, the scanning or photo-capturing device 620 is configured to scan a document 610, and is connected the cloud processing device 630 through the Internet. The scanning or photo-capturing device 620 transmits the scanned document (electronic document) to the cloud processing device 630 for processing by one or more processing procedures, and the processing procedures can refer to the related text descriptions of the Table 1. The cloud processing device 630 is connected to the database 640 and the document printing device 624 through the Internet, a virtual private network or a LAN, and processes the received scanned document and provides ID information corresponding to a cover page of the scanned document to one of the electronic devices 651, 652, 653, . . . , 65n or the document printing device 624, or transmits or stores the scanned document to one of the electronic devices 651, 652, 653, . . . , 65n.

The user can firstly log in the cloud processing device 630 through one of the electronic devices 651, 652, 653, . . . , 65n located at the local end to obtain user ID information from the cloud processing device 630 and configure a corresponding user password. After obtaining the user ID information, the user can configure one or a plurality of processing procedures of the one or a plurality of documents to be processed on the cloud processing device 630, and obtains the cover pages or the ID information corresponding to the single or a plurality of documents from the cloud processing device 630.

For the sake of simplicity, the electronic device 651 is taken as an example for description. The electronic device can be a fax machine, a database storage device, a computer, a flat panel computer, a smart phone or a handheld computing device. The user can firstly log in the cloud processing device 630 through the electronic device 651, and obtains the user ID information from the cloud processing device 630 and configures a corresponding user password. After the user ID information is obtained, the user can respectively configure corresponding processing procedures of the document to be processed on the cloud processing device 630, and the cloud processing device 630 generates corresponding processing ID information according to the corresponding processing procedures of the document and the user ID information, and finally generates and provides the ID information to the electronic device 651.

The electronic device 651 is connected to the printing device 624 through the Internet, the virtual private network or the LAN. After the user obtains the ID information through the electronic device 651, the ID information is printed on a cover page through the document printing device 624, or the ID information is printed as a one-dimensional barcode, or the ID information is printed as a two-dimensional barcode. It is noted that the ID information includes the user ID information and the processing ID information. Moreover, in a practical operation, the convenience store can provide a standard cover page, and the user can manually write the ID information on the cover page. Alternatively, the user manually attaches the one-dimensional barcode on the cover page, or manually attaches the two-dimensional barcode on the cover page. Moreover, the cloud processing system may further include an electronic tag (for example, a RFID tag) burner, which can burn the ID information on an electronic tag, and the electronic tag is attached to the cover page, and the scanning or photo-capturing device 620 simultaneously has a functionality of reading the electronic tag.

After the user obtains the complete cover pages, the user uses the scanning or photo-capturing device 620 to scan the documents and the cover pages to obtain electronic documents (scanned documents). It is noted that the cover page has to be scanned first, and then the other pages of the document are scanned. For example, the user provides the cover pages and the documents to be processed to the scanning or photo-capturing device 620, and the scanning or photo-capturing device 620 uses the optical character recognition (OCR) functionality to respectively recognize the ID information of each one of the cover pages (for example, a one-dimensional barcode, a two-dimensional barcode, or combination information of a string of characters or symbols), or read the ID information from electronic tags. The scanning or photo-capturing device 620 simultaneously obtains the scanned documents. After obtaining the recognized ID information and the scanned documents, the scanning or photo-capturing device 620 transmits the scanned documents and the recognized ID information to the cloud processing device 630 for processing. The cloud processing device 630 stores the scanned documents to the database 640, to a pre-configured path of the electronic device 651 or to one of the electronic devices 651, 652, 653, . . . , 65n according to the processing ID information of the scanned documents.

In the present embodiment, the cloud processing device 630 can be a server, which can simultaneously process a plurality of scanned documents and map the corresponding processing procedures configured by the user and the user ID information in a mapping table. The Table 1 is an exemplary mapping table, and possible implementations thereof are not repeated herein.

FIG. 7 is a schematic diagram of ID information according to another exemplary embodiment of the invention. Similar to FIG. 3, the ID information shown in FIG. 7 is a combination of a string of characters, numbers and symbols, which may include the user ID information “ID00ABC10” indicated by a reference number 71, user password information “123WqUtS” indicated by a reference number 72, which is configured to prevent the other users from stealing the user ID information, a part of the processing ID information “9876XYZ % $mno” indicated by a reference number 73, a part of the processing ID information “pabc2PQRST” indicated by a reference number 74, which is related information of the processing ID information indicated by the reference number 73, a part of the processing ID information “UVWXYZ98765” indicated by a reference number 75, a part of the processing ID information “% &#@000aci984D” indicated by a reference number 76, which is related information of the processing ID information indicated by the reference number 75, and introductions of the processing procedures thereof are not continued. Combinations of other characters, numbers or symbols in the ID information may represent other types of processing ID information and related information, for example, the scanned document corresponding to the ID information is transmitted to one or a plurality of fax numbers (not shown), or transmitted to one or a plurality of email addresses (not shown), or mailed to one or a plurality of physical mailing addresses, and actual meanings of the characters, the numbers and the symbol are not described in detail one-by-one.

When the cloud processing device 630 receives the user password information provided by the scanning or photo-capturing device 620 and determines that it is not matched to the user ID information, the cloud processing device 630 stops processing the scanned document provided by the scanning or photo-capturing device 620.

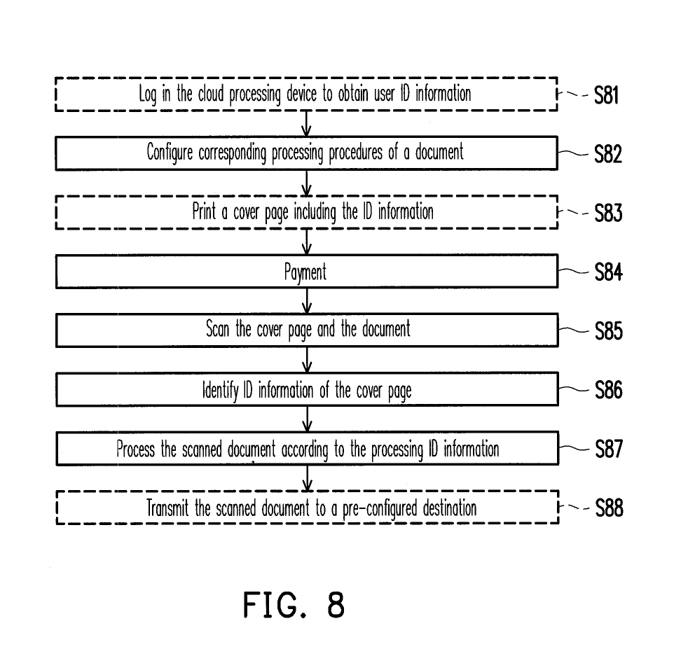

FIG. 8 is a flowchart illustrating a cloud processing method with an ID mechanism according to an exemplary embodiment of the invention. Referring to FIG. 8, the cloud processing method is adapted to the cloud processing system 60 shown in FIG. 6, which includes following steps. A user uses an electronic device to log in the cloud processing device to obtain user ID information and set user password information (step S81). The user configures corresponding processing procedures of a document to be processed on the cloud processing device through the electronic device, and obtains ID information from the cloud processing device (step S82), where the ID information includes the user ID information, the user password information and the processing ID information. The user uses a document printing device to print a cover page including the ID information (step S83). Before scanning the documents to be processed, the user firstly makes payment (step S84). It is noted that before the user makes the payment, subsequent steps S85-S88 cannot be executed.

In the present embodiment, payment of the step S84 can be carried out at the convenience store, and cash, bank cards, credit cards, a small payment mechanism or a pre-configured stored-value card can be used to make the payment. These payment procedures are not main points of the invention, and are familiar by the one with ordinary skill in the art, so that descriptions thereof are not introduced herein.

The cloud processing method further includes following steps. The user uses a scanner or photo-capturing device to scan the cover page and the document to be processed, and obtains the ID information (step S85). The scanner or photo-capturing device identifies the processing ID information of the cover page, and transmits the processing ID information and the scanned document to the cloud processing device (step S86). The cloud processing device processes the scanned document according to the processing ID information (step 87). Then, the cloud processing device transmits the scanned document to a pre-configured destination (step S88), where the pre-configured destination can be, for example, one or a plurality of email addresses, one or a plurality of fax numbers, one or a plurality of physical mailing addresses, a database, or pre-configured paths of one or a plurality of electronic devices, and so forth. When the user has obtained the user ID information, and a cloud processing of the document is performed for a next time, the step S81 can be skipped to directly execute the step S82.

In the step S85, the scanning or photo-capturing device can simultaneously transmit the ID information of the cover page, especially the user ID information and the user password information to the cloud processing device, so as to verify identity of the user or check the processing procedures to avoid the user ID information from being stolen. When the cloud processing device 630 receives the user password information provided by the scanning or photo-capturing device and determines that it is not matched to the user ID information, the cloud processing device 630 stops processing the scanned documents provided by the scanning or photo-capturing device.

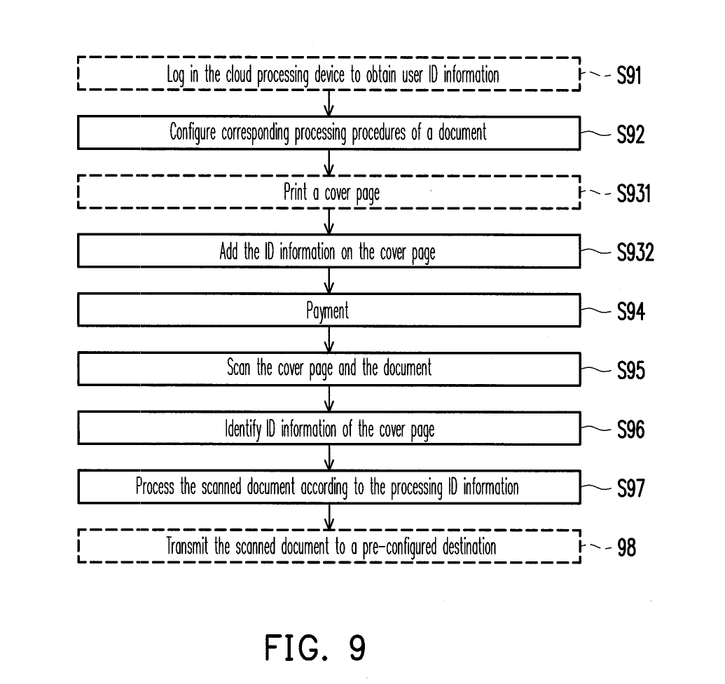

FIG. 9 is a flowchart illustrating a cloud processing method with an ID mechanism according to an exemplary embodiment of the invention. Referring to FIG. 9, the cloud processing method is similar to the cloud processing method of FIG. 8, though the cloud processing method of the embodiment further includes following steps: the user uses the document printing device to print a cover page (step S931), and the user adds the ID information on the cover page (step S932), which are configured to replace the step S83. Regarding practical implementation of the step S932, the user can attach a one-dimensional barcode or a two-dimensional barcode to the cover page, or manually write a combination of a string of characters or symbols onto the cover page, or manually attach an electronic tag on the cover page.

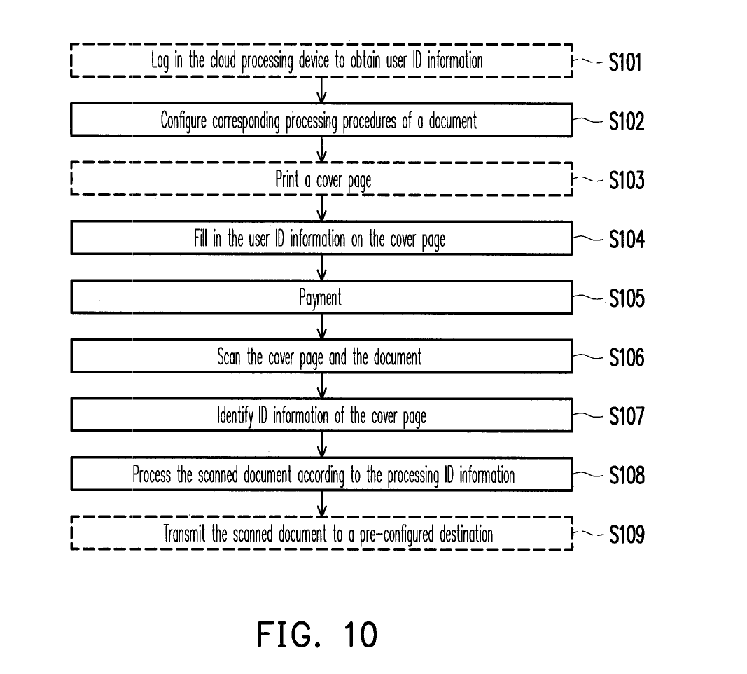

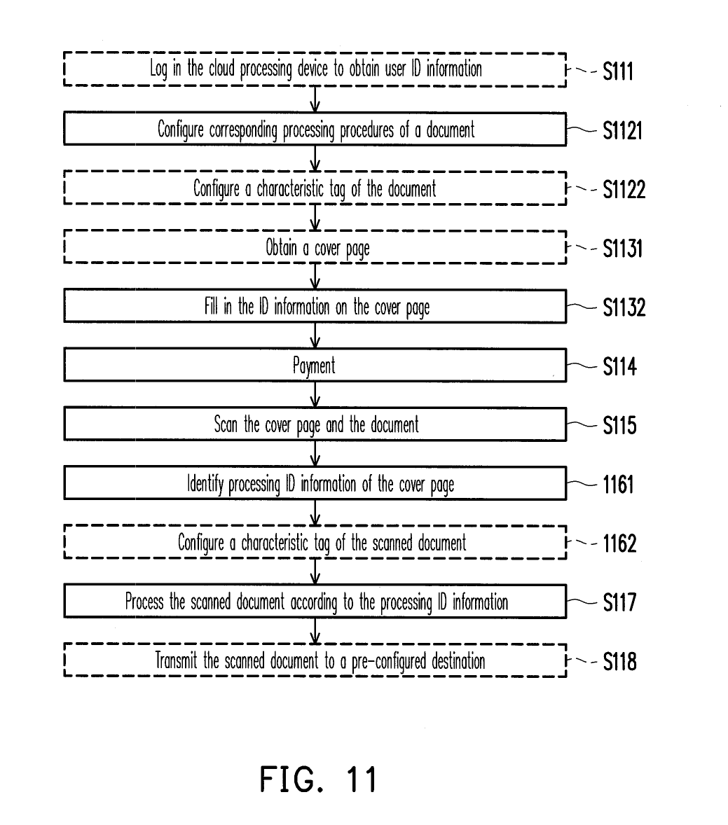

FIG. 10 is a flowchart illustrating a cloud processing method with an ID mechanism according to an exemplary embodiment of the invention. Referring to FIG. 10, the cloud processing method is similar to the cloud processing method of FIG. 9, and steps S102, S103, S105-S106 and S109 are respectively similar to the steps S92, S931, S94-S95 and S99, though steps S101, S104, S107-S108 are different to the steps S91, S932 and S96-S97. In the step S101, the user uses an electronic device to log in the cloud processing device to obtain user ID information and configure user password information, and simultaneously configure a pre-configured destination (for example, an email address). After the pre-configured destination of the document to be processed is configured, the scanned documents are all directly transmitted to the pre-configured destination through the cloud processing device. In the step S104, the user fills in the user ID information on the standard cover page. In the step S107, the scanning or photo-capturing device identifies the user ID information of the cover page, and transmits the user ID information and the scanned document to the cloud processing device. In the step S108, the cloud processing device processes the scanned document according to the user ID information.

FIG. 11 is a flowchart illustrating a cloud processing method with an ID mechanism according to an exemplary embodiment of the invention. In the embodiment of FIG. 11, the cloud processing method is adapted to the cloud processing system 10 or the cloud processing system 60, which can be used to process a non-text document, for example, a picture, a photograph, a text with a special pattern, and so forth. Moreover, in the embodiment of FIG. 11, a scanning or photo-capturing device 652 can establish keyword tags respectively corresponding to a picture to be processed, a photograph to be processed and a document to be processed. Alternatively the cloud processing device receives tags of a scanned photograph and a scanned picture that are configuerd by the user to facilitate accessing such document later.

Referring to FIG. 11, the cloud processing method is similar to the cloud processing method of FIG. 9, i.e., steps S111-S1121, S114-S1161 and S117-S118 are respectively similar to the steps S91-S92, S931, S94-S95 and S97-S98 of FIG. 9, though steps S1122, S1131-S1132 and S1162 are different to the other steps of FIG. 9. In the step S1122, the user uses an electronic device to log in the cloud processing device to obtain user IL) information and configure user password information, and simultaneously configure a characteristic tag of the document to be processed, the photograph to be processed or the picture to be processed. In step S1131, the user obtains a cover page, for example, the user prints the cover page or obtains the cover page from the convenience store. However, the step S1122 is not a necessary step. In the step S1132, the user fills in the user ID information on the standard cover page. In the step S162, the scanning or photo-capturing device identifies a characteristic of the scanned document, the scanned photograph or the scanned picture, and accordingly configures a characteristic tag of the scanned document, the scanned photograph or the scanned picture. However, the step S1162 is not a necessary step.

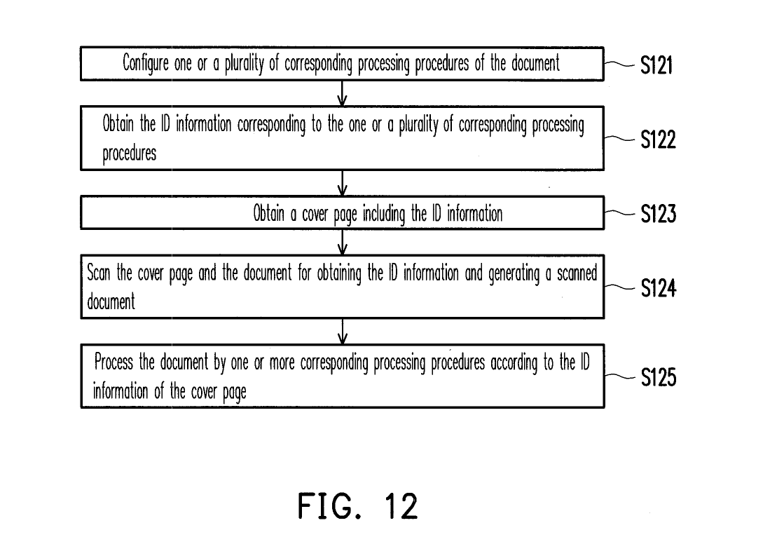

FIG. 12 is a flowchart illustrating a cloud processing method with an ID mechanism according to an exemplary embodiment of the invention. Referring to FIG. 12, the cloud processing method is adapted to process one or a plurality of documents, which includes following steps. A user uses an electronic device to connect the cloud processing device, and configures one or a plurality of corresponding processing procedures of the document to be processed on the cloud processing device (step S121). The cloud processing device generates corresponding ID information according to the corresponding processing procedures and user ID information, and the user obtains the ID information corresponding to the corresponding processing procedures from the cloud processing device (step S122). The user obtains a cover page including the ID information (step S123). The user uses the scanning or photo-capturing device to scan the cover page and the document for obtaining the ID information and generating a scanned document, and the scanning or photo-capturing device provides the ID information and the scanned document to the cloud processing device (step S124). The cloud processing device processes the document by one or more corresponding processing procedures according to the ID information of the cover page.

In the step S123, the step of obtaining the cover page including the ID information can be described in details as follow. The ID information can be printed on the cover page, or the cover page can be firstly printed, and then the user adds the ID information on the cover page, or the user manually writes the ID information on the standard cover page (which is, for example, a customized cover page provided by the convenience store). The ID information can be a combination of a string of characters or numbers or symbols, a one-dimensional barcode, a two-dimensional barcode or an electronic tag. The method of generating the combination of a string of characters or numbers or symbols, the one-dimensional barcode, the two-dimensional barcode or the electronic tag can be similar to that described in the embodiments of FIG. 1 to FIG. 6, which is not repeated herein.

In the present embodiment, the ID information may merely include the user ID information and the processing ID information. However, in other embodiments, the ID information may include the user ID information, the processing ID information and the user password information. Moreover, the ID information may further include other information required by the processing ID information, for example, a pre-configured path of the electronic device where a specific document or a specific page is transmitted to or stored to, one or a plurality of email addresses, one or a plurality of fax numbers, or one or a plurality of physical mailing addresses.

The one or a plurality of corresponding processing procedures include transmitting the scanned document to one or a plurality of email addresses, transmitting the scanned document to one or a plurality of fax numbers, transmitting the scanned document to one or a plurality of electronic devices, storing the scanned document to a database, or any combination of the aforementioned various processing procedures. For example, any combination of the various processing procedures can be, for example, to transmit a first set of pages (for example, a first to fifth pages) of a document to be processed to an email address, transmit a second set of pages (for example, a sixth to seventh pages) of the document to be processed to a fax number, and transmit a third set of pages (for example, an eighth to ten pages) of the document to be processed to a pre-configured path of the electronic device, and stores a fourth set of pages (for example, an eleventh to fifteenth pages) of the document to be processed to a database.

Before the step of configuring one or a plurality of corresponding processing procedures of the document to be processed, the cloud processing method with the ID mechanism further includes: the user firstly logs in the cloud processing device and obtains the user ID information through the cloud processing device. Alternatively, before the step of configuring one or a plurality of corresponding processing procedures of the document, the cloud processing method with the ID mechanism further includes: the user ID information is obtained, and the user configures a specific destination of the document to be processed.

The step of processing the scanned document by one or more corresponding processing procedures according to the ID information of the cover page includes: the scanned document is transmitted to the pre-configured destination according to the user ID information, where the ID information may merely include the user ID information. After the step of setting one or a plurality of corresponding processing procedures of the document to be processed, the cloud processing method with the ID mechanism further includes: one or a plurality of characteristic tags of the document to be processed is configured at the cloud processing device. Moreover, after the step of scanning the cover page and the document to be processed, the cloud processing method with the ID mechanism further includes: one or a plurality of characteristic tags of the scanned document is configured to facilitate searching and accessing the scanned document in the future.

In summary, in the aforementioned exemplary embodiments, the invention provides the cloud processing method with the ID mechanism and the system using the same method. By configuring one or more corresponding processing procedures for the document, the identification information of the corresponding processing procedures is obtained from the cloud processing device, and the cover page having the identification information is obtained, and the scanning or photo-capturing device is configured to obtain the scanned document, and then the cloud processing device processes the documents by one or more corresponding processing procedures according to the identification information of the cover page. In this way, a single document can be processed by a plurality of corresponding processing procedures by performing one configuring procedure and one scanning procedure.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A cloud processing method with an identification mechanism, adapted to process a document, comprising:
configuring at least one corresponding processing procedure for the document;
obtaining identification information of the at least one corresponding processing procedure;
obtaining a cover page comprising the identification information;
scanning the cover page and the document for obtaining the identification information and generating a scanned document; and
processing the document by the at least one corresponding processing procedure according to the identification information of the cover page.

2. The cloud processing method with the identification mechanism as claimed in claim 1, wherein the step of obtaining the cover page comprising the identification information comprises:
printing the identification information on the cover page.

3. The cloud processing method with the identification mechanism as claimed in claim 1, wherein the step of obtaining the cover page comprising the identification information comprises:
printing the cover page; and
adding the identification information on the cover page.

4. The cloud processing method with the identification mechanism as claimed in claim 1, wherein the identification information is a combination of a string of characters, numbers or symbols, a one-dimensional barcode, a two-dimensional barcode or an electronic tag.

5. The cloud processing method with the identification mechanism as claimed in claim 1, wherein the identification information comprises user identification information and processing identification information.

6. The cloud processing method with the identification mechanism as claimed in claim 5, wherein the identification information further comprises user password information.

7. The cloud processing method with the identification mechanism as claimed in claim 5, wherein the identification information further comprises other information required by the processing identification information.

8. The cloud processing method with the identification mechanism as claimed in claim 5, wherein the at least one corresponding processing procedure is to transmit the scanned document to at least one email address, transmit the scanned document to at least one fax number, transmit the scanned document to at least one electronic device, transmit the scanned document to a database, or any combination of the aforementioned processing procedures.

9. The cloud processing method with the identification mechanism as claimed in claim 1, before the step of configuring the at least one corresponding processing procedure for the document, the method further comprises:
obtaining user identification information.

10. The cloud processing method with the identification mechanism as claimed in claim 1, before the step of configuring the at least one corresponding processing procedure for the document, the method further comprises:
obtaining user identification information; and
setting a pre-configured destination of the document.

11. The cloud processing method with the identification mechanism as claimed in claim 10, wherein the step of processing the document by the at least one corresponding processing procedure according to the identification information of the cover page comprises:
transmitting the scanned document to the pre-configured destination according to the user identification information, wherein the identification information comprises the user identification information.

12. The cloud processing method with the identification mechanism as claimed in claim 1, wherein after the step of configuring the at least one corresponding processing procedure for the document, the method further comprises:
setting a characteristic tag of the document.

13. The cloud processing method with the identification mechanism as claimed in claim 1, wherein after the step of scanning the cover page and the document, the method further comprises:
setting a characteristic tag of the scanned document.

14. A cloud processing system, adapted to process a document, comprising:
a cloud processing device, configured for receiving at least one corresponding processing procedure of the document configured by a user, and generating identification information of the at least one corresponding processing procedure;
a document printing device, connected to the cloud processing device, configured for generating a cover page comprising the identification information; and
a scanning or photo-capturing device, connected to the cloud processing device, configured for scanning the cover page and the document for obtaining the identification information and generating a scanned document, and providing the scanned document and the identification information to the cloud processing device, wherein the cloud processing device processes the document by the at least one corresponding processing procedure according to the identification information of the cover page.

15. The cloud processing system as claimed in claim 14, wherein the document printing device prints the identification information on the cover page.

16. The cloud processing system as claimed in claim 14, wherein the document printing device prints the cover page and the identification information, and the user adds the identification information on the cover page.

17. The cloud processing system as claimed in claim 14, wherein the identification information is a combination of a string of characters, numbers or symbols, a one-dimensional barcode, a two-dimensional barcode or an electronic tag.

18. The cloud processing system as claimed in claim 14, wherein the identification information comprises user identification information and processing identification information.

19. The cloud processing system as claimed in claim 16, wherein the identification information further comprises user password information.

20. The cloud processing system as claimed in claim 16, wherein the at least one corresponding processing procedure is to transmit the scanned document to at least one email address, transmit the scanned document to at least one fax number, transmit the scanned document to at least one electronic device, transmit the scanned document to a database, or any combination of the aforementioned processing procedures.

21. The cloud processing system as claimed in claim 14, wherein the document printing device is integrated with the scanning or photo-capturing device.
